(19) United States
(12) Patent Application Publication
(10) Pub. No.: US 2011/0203593 A1
(43) Pub. Date: Aug. 25, 2011

(54) MASK

(75) Inventors: Makoto Ishigami, Kagawa-ken (JP); Naohito Takeuchi, Kagawa-ken (JP)

(73) Assignee: Uni-Charm Corporation, Ehime-ken (JP)

(21) Appl. No.: 12/991,917

(22) PCT Filed: May 14, 2009
(86) PCT No.: PCT/JP2009/002129

§ 371 Date: Mar. 31, 2011

(30) Foreign Application Priority Data
May 15, 2008 (JP) 2008-128869

(51) Int. Cl. A62B 7/10

(52) U.S. Cl. 128/206.13

(57) ABSTRACT

An effective technique for balancing mask breathability and mask trapping capability at higher levels is provided in a mask to be worn on a wearer's face. A mask 1 has a mask body 10 that covers at least wearer's mouth and nose and a pair of ear straps 20 that extend from both sides of the mask body 10 and are designed to be hooked around wearer's ears. The mask body 10 includes a first fiber sheet and a second fiber sheet which are electret nonwoven fabric sheets formed of polyolefin fiber. The first fiber sheet is a nonwoven fabric sheet having an average fiber diameter of 0.5 to 3 μm and a basis weight of 1.5 to 5 g/m², and the second fiber sheet is a nonwoven fabric sheet having a larger average fiber diameter and a heavier basis weight than the first fiber sheet.

### FIELD OF THE INVENTION

The invention relates to a mask worn on a wearer's face.

### BACKGROUND OF THE INVENTION

Japanese laid-open Patent Publication No. 2007-37737 discloses a mask, particularly a three-dimensional mask for covering the mouth and nose of a wearer. In this three-dimensional mask, in order to obtain a desired effect as a barrier against viruses such as cold viruses without giving the wearer a feeling of suffocation, electret fiber sheets are used to improve the breathability and the trapping capability of the mask. In designing a three-dimensional mask of this type using electret fiber sheets, further improvement is required to balance the competing objectives for mask breathability and mask trapping capability at higher levels.

### DISCLOSURE OF THE INVENTION

It is, accordingly, an object of the invention to provide a mask to be worn on a wearer's face in which competing objectives for mask breathability and mask trapping capability can be balanced at higher levels.

Above-described object can be achieved by the claimed invention.

A mask according to the invention is arranged and adapted to be worn on a wearer's face and includes at least a mask body, a pair of ear straps. The mask may be of disposable type adapted for a single or multiple use or reusable type which can be reused by washing.

The mask body is designed to cove at least the mouth and nose of a wearer. The pair of ear straps extend from both sides of the mask body and are designed to be hooked around wearer's ears. The ear straps are preferably formed of a stretch material so as to prevent excessive load on the ears. Further, the mask body is preferably formed of a material which is soft and comfortable to wear and has lower stretchiness than the ear straps so that the mask body lends itself to be retained in shape when the mask is worn on the face. The mask body may be planer or three-dimensional. In the case of a three-dimensional mask, it is essential for the mask body to take a three-dimensional shape at least when the mask is worn. Therefore, the mask body may be designed to be three-dimensional not only when the mask is worn but when the mask is not worn. Alternatively, the mask body may be designed to take a three-dimensional form when the mask is worn and to be folded into a planar form in a predetermined manner when the mask is not worn. A sheet piece which forms the mask body is a sheet-like structure typically formed by fixing or entangling fibers by mechanical, chemical or heat treatment. Typically, it is formed of nonwoven fabric which partly includes thermal melting (thermoplastic) fibers and thus can be heat-sealed (fusion bonded).

The mask body particularly includes a first fiber sheet and a second fiber sheet which are electret nonwoven fabric sheets formed of polyolefin fiber and stacked one on the other such that the first sheet is arranged on a wearer's side of the second fiber sheet when the mask is worn. This construction widely includes a construction in which the mask body in its entirety or in part has a two-layer structure having the first and second fiber sheets, and a construction in which the mask body in its entirety or in part has a multilayer structure of three or more layers having the first and second fiber sheets and one or more additional fiber sheets. The “nonwoven fabric sheet formed of polyolefin fiber” here widely includes not only a nonwoven fabric sheet formed only of polyolefin fiber, but a nonwoven fabric sheet formed of polyolefin fiber and other fiber in mixture. The polyolefin fiber typically includes polypropylene fiber, polyethylene fiber and poly1-butene fiber. Further, the “electret” here is defined as a dielectric state in which the surface of the polyolefin fiber is provided with a predetermined amount of positive or negative charge and polarized by known electret treatment. Specifically, the nonwoven fabric sheet containing polyolefin fiber can be converted into a desired electret.

Particularly, in this mask body, the first fiber sheet comprises a nonwoven fabric sheet having an average fiber diameter of 0.5 to 3 μm and a basis weight of 1.5 to 5 g/m², and the second fiber sheet comprises a nonwoven fabric sheet having a larger average fiber diameter and a heavier basis weight than the first fiber sheet. Particularly, the mask trapping capability can be increased by reducing the average fiber diameter and the basis weight of the first fiber sheet which is subjected to electret treatment, while the mask breathability can be ensured by relatively increasing the average fiber diameter and the basis weight of the second fiber sheet which is subjected to electret treatment. Therefore, with such a construction, the mask breathability and the mask trapping capability can be balanced at higher levels.

Further, in the mask body constructed as described above, preferably, the second fiber sheet comprises a nonwoven fabric sheet having an average fiber diameter of 15 to 30 μm and a basis weight of 18 to 50 g/m². With such a construction, further by properly selecting the average fiber diameter and the basis weight of the second fiber sheet which is subjected to electret treatment, the mask breathability and the mask trapping capability can be further enhanced.

Further, preferably, the mask body constructed as described above has a third fiber sheet which is stacked on a side of the first fiber sheet opposite from the second fiber sheet, and the third fiber sheet comprises a nonwoven fabric sheet having an average fiber diameter of 10 to 50 μm and a basis weight of 20 to 40 g/m². The third fiber sheet having such a construction which comes in direct contact with the face (skin) of the wearer is suitably used as a nice and soft nonwoven fabric sheet. Further, the third fiber sheet may be an electret nonwoven fabric sheet formed of polyolefin fiber, like the first and second fiber sheets, or it may be a non-electret nonwoven fabric sheet formed of polyolefin fiber.

As described above, according to this invention, in a mask to be worn on a wearer's face, particularly, both of the first and second fiber sheets which are stacked one on the other and form the mask body in its entirety or in part are formed by electret nonwoven fabric sheets of polyolefin fiber, and the average fiber diameter and the basis weight of each of the fiber sheets are properly selected. As a result, the mask breathability and the mask trapping capability can be balanced at higher levels.

### DETAILED DESCRIPTION OF THE EMBODIMENT OF THE INVENTION

The construction and properties of a mask 1 are described in detail as a representative embodiment of the “mask” according to the invention with reference to FIGS. 1 to 4.

The entire construction of the mask 1 according to this embodiment is shown in FIG. 1. A mask 1 of this embodiment is designed as a disposable mask for single or multiple use which can be used once or several times. The mask 1 is suitably used as a mask having a function as a barrier against viruses such as cold viruses, or against pollens as necessary. The mask 1 mainly includes a mask body 10 and a pair of ear straps 20.

### (Construction of Mask Body 10)

The mask body 10 of the mask 1 is designed to cover the mouth and nose of a wearer. The mask body 10 corresponds in part or in entirety to the “mask body” according to this invention. The mask body 10 includes a right sheet piece 10a that covers right half of the wearer's face and a left sheet piece 10b that covers left half of the wearer's face. The right and left sheet pieces 10a, 10b are connected together by heat-sealing and forms a three-dimensional shape (three-dimensional structure) having a concave on a wearing face on the side facing the wearer. A vertically extending joint edge 10c is formed in a joint between the right and left sheet pieces 10a, 10b, so that the mask body 10 is divided into right and left halves by the joint edge 10c.

When the mask is worn, the mask body 10 is unfolded into a three-dimensional form with the right and left sheet pieces 10a, 10b separated away from each other. When the mask is in storage or not in use, the mask body 10 folds flat with the right and left sheet pieces 10a, 10b in face contact with each other. Further, it is essential for the mask body 10 to form a three-dimensional form at least when the mask is worn. Therefore, the mask body 10 may be designed to be three-dimensional not only when the mask is worn but when the mask is not worn. Further, preferably, the mask body 10 is soft and comfortable to wear and has lower stretchiness than the ear straps 3 so that the mask body 10 lends itself to be retained in a three-dimensional form when the mask is worn on the face.

The sectional construction of the mask body 10, or the right and left sheet pieces 10a, 10b is shown in FIG. 2. As shown in FIG. 2, the mask body 10 has a three-layer structure having a first fiber sheet 13, a second fiber sheet 14 which forms a mask outer surface 11 when the mask is worn, and a third fiber sheet 15 which forms a mask inner surface (wearing face) 12 facing the wearer when the mask is worn, which are stacked on top of each other in layers and joined together. Each of the first fiber sheet 13, the second fiber sheet 14 and the third fiber sheet 15 is an integrally formed nonwoven fabric sheet, and it may be formed of one piece of seamless nonwoven fabric sheet, or it may be formed of a plurality of nonwoven fabric sheets stacked in layers or butted and joined together.

The first fiber sheet 13 is an electret nonwoven fabric sheet containing polypropylene fiber. By converting the sheet into an electret (electret treatment), the surface of the polypropylene fiber is provided with a predetermined amount of positive or negative charge so that it is polarized and turned into a dielectric state. Specifically, the nonwoven fabric sheet containing polypropylene fiber can be converted into a desired electret (by a desired electret treatment). As the first fiber sheet 13, typically, a melt-blow (melt-blown) nonwoven fabric sheet manufactured by a melt-blowing method (melt-blown method) can be used, and preferably, it has an average fiber diameter of 0.5 to 3 μm and a basis weight of 1.5 to 5 g/m². In this case, the first fiber sheet 13 is an electret nonwoven fabric sheet containing at least polyethylene fiber, and it may be formed only of polypropylene fiber or it may be formed of polypropylene fiber and additional fiber, such as polyethylene fiber. The first fiber sheet 13 here is a feature that corresponds to the “first fiber sheet” according to this invention.

Like the first fiber sheet 13, the second fiber sheet 14 is an electret nonwoven fabric sheet containing polypropylene fiber. The second fiber sheet 14 can be appropriately subjected to electret treatment together with the first fiber sheet 13 or independently of the first fiber sheet 13. As the second fiber sheet 14, typically, a spun lace nonwoven fabric sheet manufactured by a spun lacing method, a through-air nonwoven fabric sheet manufactured by a through-air bonding method, a spunbond nonwoven fabric sheet manufactured by a spun bonding method, or a needle punch nonwoven fabric sheet manufactured by a needle punching method can be used, and preferably, it has an average fiber diameter of 15 to 30 μm and a basis weight of 18 to 50 g/m². In this case, the second fiber sheet 14 is an electret nonwoven fabric sheet containing at least polypropylene fiber, and it may be formed only of polypropylene fiber or it may be formed of polypropylene fiber and additional fiber, such as polyethylene fiber. The second fiber sheet 14 here is a feature that corresponds to the “second fiber sheet” according to this invention.

Unlike the first and second fiber sheets 13, 14, the third fiber sheet 15 is not an electret sheet. The third fiber sheet 15 preferably comprises a low-density point bond nonwoven fabric sheet, typically containing polyethylene terephthalate fiber and polyethylene fiber and point-bonded by a pressure roll (for example, a nonwoven fabric sheet having an average fiber diameter of 10 to 50 μm, a basis weight of 20 to 40 g/m², a thickness of 0.20 mm or more and an air permeability of 150 cc/cm²/sec). The third fiber sheet 15 having such a construction which comes in direct contact with the face (skin) of the wearer is suitably used as a nice and soft nonwoven fabric sheet. The third fiber sheet 15 here is a feature that corresponds to the “third fiber sheet” according to this invention. Further, the third fiber sheet 15 may also be formed of an electret polypropylene nonwoven fabric sheet, as necessary.

### (Construction of Ear Straps 20)

The ear straps 20 extend from right and left sides of the mask body 10 or from free ends of the right and left sheet pieces 10a, 10b. The ear strap 20 here is a feature that corresponds to the “ear strap” according to this invention. The ear straps 20 are formed separately from the mask body 10 and lapped and bonded onto the mask body 2. The ear straps 20 may be integrally formed with the mask body 10. Further, each of the ear straps 20 has a ring-like shape having an opening 21. When the mask 1 is worn, the opening 21 of the ear strap 20 is hooked around the wearer's ear with the wearer's face, or particularly the nose and mouth, covered with the mask body 10. The ear strap 20 is formed of nonwoven fabric of thermoplastic synthetic fibers, and preferably formed of a stretch material so as to prevent excessive load on the ear. For example, the ear strap 20 suitably has a stretch layer of inelastically extensible fibers (for example, nonwoven fabric formed by fusion-bonding propylene continuous fibers) and an elastic layer of elastically stretchable fibers (for example, nonwoven fabric formed by using elastic yarn of thermoplastic synthetic fibers such as elastomer and urethane) which are stacked one on the other.

Hereinafter, quantitative performance evaluations are described in order to verify the mask breathability and mask trapping capability of the mask body 10 according to this representative embodiment. In the evaluations, the air permeability (cc/cm²/sec) for breathability evaluations and the trapping efficiency (%) for trapping capability evaluations were measured on each of specimens of the following examples 1 to 10 and comparative examples 1 to 3. As for the measurement of the air permeability, the amount (cc/cm²/sec) of air passing through each of the specimens was measured under predefined conditions by using a well-known Frazir tester. As for the measurement of the trapping efficiency, bacterial filtration efficiency (BFE) (%) was measured according to the testing method specified in ASTM F2101.

### Specimen of Example 1

As for a specimen of example 1, an electret polypropylene melt-blown nonwoven fabric sheet (average fiber diameter: 1.5 μm, basis weight: 2 g/m²) was used as the nonwoven fabric sheet corresponding to the first fiber sheet 13. An electret polypropylene spun lace nonwoven fabric sheet (average fiber diameter: 17.6 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 2

As for a specimen of example 2, an electret polypropylene melt-blown nonwoven fabric sheet (average fiber diameter: 1.5 μm, basis weight: 2 g/m²) was used as the nonwoven fabric sheet corresponding to the first fiber sheet 13. An electret polypropylene spun bond nonwoven fabric sheet (average fiber diameter: 17.6 μm, basis weight: 30 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 3

As for a specimen of example 3, an electret polypropylene melt-blown nonwoven fabric sheet (average fiber diameter: 1.5 μm, basis weight: 2 g/m²) was used as the nonwoven fabric sheet corresponding to the first fiber sheet 13. An electret polyethylene terephthalate/polyethylene through-air nonwoven fabric sheet (average fiber diameter: 15.4 μm, basis weight: 30 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 4

As for a specimen of example 4, an electret polypropylene melt-blown nonwoven fabric sheet (average fiber diameter: 3 μm, basis weight: 2 g/m²) was used as the nonwoven fabric sheet corresponding to the first fiber sheet 13. An electret polypropylene spun lace nonwoven fabric sheet (average fiber diameter: 17.6 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 5

As for a specimen of example 5, an electret polypropylene melt-blown nonwoven fabric sheet (average fiber diameter: 1 μm, basis weight: 2 g/m²) was used as the nonwoven fabric sheet corresponding to the first fiber sheet 13. An electret polypropylene spun lace nonwoven fabric sheet (average fiber diameter: 17.6 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 6

As for a specimen of example 6, an electret polypropylene melt-blown nonwoven fabric sheet (average fiber diameter: 1 μm, basis weight: 3 g/m²) was used as the nonwoven fabric sheet corresponding to the first fiber sheet 13. An electret polypropylene spun lace nonwoven fabric sheet (average fiber diameter: 17.6 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 7

As for a specimen of example 7, an electret polypropylene melt-blown nonwoven fabric sheet (average fiber diameter: 1 μm, basis weight: 5 g/m²) was used as the nonwoven fabric sheet corresponding to the first fiber sheet 13. An electret polypropylene spun lace nonwoven fabric sheet (average fiber diameter: 17.6 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 8

As for a specimen of example 8, an electret polypropylene melt-blown nonwoven fabric sheet (average fiber diameter: 1.5 μm, basis weight: 2 g/m²) was used as the nonwoven fabric sheet corresponding to the first fiber sheet 13. An electret polypropylene spun lace nonwoven fabric sheet (average fiber diameter: 21.5 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 9

As for a specimen of example 9, an electret polypropylene melt-blown nonwoven fabric sheet (average fiber diameter: 1.5 μm, basis weight: 2 g/m²) was used as the nonwoven fabric sheet corresponding to the first fiber sheet 13. An electret polypropylene spun lace nonwoven fabric sheet (average fiber diameter: 24.8 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Example 10

As for a specimen of example 10, an electret polypropylene melt-blown nonwoven fabric sheet (average fiber diameter: 1.5 μm, basis weight: 2 g/m²) was used as the nonwoven fabric sheet corresponding to the first fiber sheet 13. An electret polypropylene spun lace nonwoven fabric sheet (average fiber diameter: 17.6 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Comparative Example 1

As for a specimen of comparative example 1, an electret polypropylene melt-blown nonwoven fabric sheet (average fiber diameter: 2.5 μm, basis weight: 20 g/m²) was used as the nonwoven fabric sheet corresponding to the first fiber sheet 13. A non-electret polyethylene terephthalate/polyethylene point bond nonwoven fabric sheet (average fiber diameter: 26 μm, basis weight: 30 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Comparative Example 2

As for a specimen of comparative example 2, an electret polypropylene melt-blown nonwoven fabric sheet (average fiber diameter: 8 μm, basis weight: 2 g/m²) was used as the nonwoven fabric sheet corresponding to the first fiber sheet 13. An electret polypropylene spun lace nonwoven fabric sheet (average fiber diameter: 17.6 μm, basis weight: 40 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### Specimen of Comparative Example 3

As for a specimen of comparative example 3, an electret polypropylene melt-blown nonwoven fabric sheet (average fiber diameter: 1.5 μm, basis weight: 2 g/m²) was used as the nonwoven fabric sheet corresponding to the first fiber sheet 13. An electret polypropylene spun lace nonwoven fabric sheet (average fiber diameter: 17.6 μm, basis weight: 20 g/m²) was used as the nonwoven fabric sheet corresponding to the second fiber sheet 14. Further, a non-electret polyethylene terephthalate/polyethylene point bond nonwoven fabric sheet (average fiber diameter: 17.6 μm, basis weight: 30 g/m²) was used as the nonwoven fabric sheet corresponding to the third fiber sheet 15.

### (Evaluations of Mask Breathability and Mask Trapping Capability)

The mask breathability and the mask trapping capability of each of the specimens of the above-described examples 1 to 10 and comparative examples 1 to 3 are explained with reference to FIGS. 3 and 4. FIG. 3 shows measurements of the air permeability and the trapping efficiency of each of the specimens of the above-described examples 1 to 10 and comparative examples 1 to 3 in this embodiment. FIG. 4 is a graph showing the correlation between the air permeability and the trapping efficiency of each of the specimens of the above-described examples 1 to 10 and comparative examples 1 to 3 in this embodiment. In FIG. 4, examples 1 to 10 are plotted with ∘ (open dots), and comparative examples 1 to 3 are plotted with (centered dots).

As shown in FIGS. 3 and 4, it was verified that, when a reference value of the air permeability relating to the mask breathability is set to 70 cc/cm²·sec or more and a reference value of the trapping efficiency relating to the mask trapping capability is set to 90% or more, all of the examples 1 to 10 fall within the reference range defined by the reference values, while all of the comparative examples 1 to 3 fall outside this reference range. The range of the reference value of the air permeability of 70 cc/cm²·sec or more is defined as a range in which a wearer does not have a feeling of suffocation at all even if no clearance is provided between the mask body 10 and the face of the wearer. Further, the range of the reference value of the trapping efficiency of 90% or more is defined as a range in which the barrier effect against viruses such as cold viruses can be reliably obtained.

In comparative example 1, the air permeability is far below the reference value. Therefore, it was judged as having limitations in satisfying both of the reference values of the air permeability and the trapping efficiency solely by electret treatment of only the first fiber sheet 13 even if the average fiber diameter and the basis weight are adjusted. Further, in comparison between comparative example 1 and comparative examples 2, 3, comparative example 1 was evaluated as being able to have a substantially increased air permeability if both of the first and second fiber sheets 13, 14 are subjected to electret treatment. Comparative examples 2, 3 however have a lower trapping efficiency than comparative example 1. Therefore, the inventors judged that, on the precondition that both of the first and second fiber sheets 13, 14 are subjected to electret treatment, if the average fiber diameter and the basis weight of each of the first and second fiber sheets 13, 14 are properly adjusted based on the results of evaluation of the mask breathability and the mask trapping capability of each of examples 1 to 10, both the air permeability and the trapping efficiency can satisfy the respective reference values.

It is effective if the first fiber sheet 13 is designed to have a smaller average fiber diameter and a lighter basis weight than the second fiber sheet 14 (the second fiber sheet 14 is designed to have a larger average fiber diameter and a heavier basis weight than the first fiber sheet 13). Further, in specifically setting the average fiber diameter and the basis weight of the first and second fiber sheets 13, 14, further quantitative performance evaluations as described below were conducted. In the performance evaluations, in order to determine optimum average fiber diameter and basis weight of each of the first and second fiber sheets 13, 14, the air permeability and the trapping efficiency of nonwoven fabric sheets corresponding to the fiber sheets and varying in average fiber diameter and basis weight were measured in the above-described method.

The optimum average fiber diameter and basis weight of the first fiber sheet 13 are explained with reference to FIGS. 5 and 6. FIG. 5 is a graph showing the relationship between the average fiber diameter (μm) and the air permeability (%) and trapping efficiency (cc/cm²·sec) of a nonwoven fabric sheet corresponding to a first fiber sheet 13, and FIG. 6 is a graph showing the relationship between the basis weight (g/m²) and the air permeability (%) and trapping efficiency (cc/cm²·sec) of the first fiber sheet 13. In this case, an electret polypropylene melt-blown nonwoven fabric sheets (average fiber diameter: 0.5 to 4 μm, basis weight: 1 to 6 g/m²) was used as the nonwoven fabric sheet corresponding to the first fiber sheet 13, and electret polypropylene spun lace nonwoven fabric sheets (average fiber diameter: 20 μm, basis weight: 40 g/m²) was used as the nonwoven fabric sheet corresponding to the second fiber sheet 14.

From the results shown in FIGS. 5 and 6, it was verified that the mask breathability can be increased to a level of the air permeability of 70 cc/cm²·sec and the mask trapping capability can be increased to a level of the trapping efficiency of 90% if the first fiber sheet 13 has an average fiber diameter of 0.5 to 3 μm which is smaller than the second fiber sheet 14 and has a basis weight of 1.5 to 5 g/m² which is lighter than the second fiber sheet 14. Further, it was also verified that the optimum ranges of the average fiber diameter and the basis weight of the first fiber sheet 13 are not substantially changed even if the average fiber diameter and the basis weight of the second fiber sheet 14 are changed in the neighborhood of 20 μm and the neighborhood of 40 g/m², respectively.

Similarly, the optimum average fiber diameter and basis weight of the second fiber sheet 14 are explained with reference to FIGS. 7 and 8. FIG. 7 is a graph showing the relationship between the average fiber diameter (μm) and the air permeability (%) and trapping efficiency (cc/cm²·sec), and FIG. 8 is a graph showing the relationship between the basis weight (g/m²) and the air permeability (%) and trapping efficiency (cc/cm²·sec). In this case, an electret polypropylene spun lace nonwoven fabric sheets (average fiber diameter: 10 to 40 μm, basis weight: 20 to 60 g/m²) was used as the nonwoven fabric sheet corresponding to the second fiber sheet 14, and an electret polypropylene melt-blown nonwoven fabric sheets (average fiber diameter: 1.5 μm, basis weight: 2 g/m²) was used as the nonwoven fabric sheet corresponding to the first fiber sheet 13.

From the results shown in FIGS. 7 and 8, it was verified that the mask breathability can be increased to a level of the air permeability of 70 cc/cm²·sec and the mask trapping capability can be increased to a level of the trapping efficiency of 90% if the second fiber sheet 14 has a larger average fiber diameter of 15 to 30 μm than the first fiber sheet 13 and has a heavier basis weight of 18 to 50 g/m² than the first fiber sheet 13. Further, it was also verified that the optimum ranges of the average fiber diameter and the basis weight of the second fiber sheet 14 are not substantially changed even if the average fiber diameter and the basis weight of the first fiber sheet 13 are changed in the neighborhood of 1.5 μm and the neighborhood of 2 g/m², respectively.

As described above, the mask 1 of this embodiment is provided with a new mask performance by greatly varying the average fiber diameter and the basis weight of the electret nonwoven fabric sheets in the direction of the thickness of the mask body 10. Specifically, by using an electret nonwoven fabric sheet having an average fiber diameter of 0.5 to 3 μm and a basis weight of 1.5 to 5 g/m² as the first fiber sheet 13 and an electret nonwoven fabric sheet having an average fiber diameter of 15 to 30 μm and a basis weight of 18 to 50 g/m² as the second fiber sheet 14, a mask structure having the mask breathability and the mask trapping capability balanced at higher levels can be realized. Further, if necessary, after choosing an electret nonwoven fabric sheet having an average fiber diameter of 0.5 to 3 μm and a basis weight of 1.5 to 5 g/m² as the first fiber sheet 13, an electret nonwoven fabric sheet having an average fiber diameter and a basis weight which are both beyond the above-described numerical ranges for the first fiber sheet (average fiber diameter: 0.5 to 3 μm, basis weight: 1.5 to 5 g/m²) can be chosen as the second fiber sheet 14. In this case, the mask trapping capability can be increased by reducing the average fiber diameter and the basis weight of the first fiber sheet 13 which is subjected to electret treatment, while the mask breathability can be ensured by relatively increasing the average fiber diameter and the basis weight of the second fiber sheet 14 which is subjected to electret treatment.

Further, in this embodiment, because the nonwoven fabric sheets of the first and second fiber sheets 13, 14 are formed of polypropylene fiber which is one of polyolefin fibers, their electret treatment can be particularly easily performed, and a low-cost mask can be provided which is advantageous in terms of cost. Further, the nonwoven fabric sheets of the first and second fiber sheets 13, 14 may be formed of polyolefin fiber other than polypropylene fiber, such as polyethylene fiber and poly 1-butene fiber.

### Other Embodiments

The invention is not limited to the embodiment as described above, but rather, may be added to, changed, replaced with alternatives or otherwise modified. For example, the following modifications can be made to this embodiment.

In the above embodiment, the mask is described as having the mask body 10 of a three-layer structure having the first, second and third fiber sheets 13, 14, 15 which are stacked on top of each other in layers. In this invention, however, it is essential for the mask body to have at least a nonwoven fabric sheet corresponding to the first fiber sheet 13 and a nonwoven fabric sheet corresponding to the second fiber sheet 14. Therefore, a structure having two or more layers can be appropriately selected as the structure of the mask body. Further, if any other fiber sheet is provided in addition to the nonwoven fabric sheet corresponding to the first fiber sheet 13 and the nonwoven fabric sheet corresponding to the second fiber sheet 14, the number and position of the additional fiber sheets can be appropriately changed as necessary. Further, in this invention, an area of the mask in which the nonwoven fabric sheet corresponding to the first fiber sheet 13 and the nonwoven fabric sheet corresponding to the second fiber sheet 14 are stacked one on the other can form the mask body in its entirety or in part.

Further, in this invention, it is essential for the nonwoven fabric sheet corresponding to the first fiber sheet 13 and the nonwoven fabric sheet corresponding to the second fiber sheet 14 to contain polyolefin fiber in order to be subjected to desired electret treatment. Therefore, as these sheets, for example, not only a nonwoven fabric sheet formed only of polyolefin fiber, but a nonwoven fabric sheet formed of polyolefin fiber and other fiber in mixture can be appropriately used.

Further, according to the above embodiment, the mask body 10 is formed by heat-sealing the right and left sheet pieces 10a, 10b. On the other hand, the mask body can be formed by joining a plurality of sheet pieces in entirety or in part by various joining methods including heat-sealing.

Further, in this embodiment, the mask is described as being of disposable type designed for a single or multiple use which can be used once or several times, but this invention can also be applied to a mask of reusable type which can be reused by washing, provided that the materials of the mask body and the ear straps are appropriately selected. Further, in this embodiment, the mask body is described as being three-dimensional, but this invention can also be applied to a mask having a planar mask body.

### BRIEF DESCRIPTION OF THE DRAWINGS

FIG. 1 is a perspective view of a mask 1 according to the embodiment of the invention.

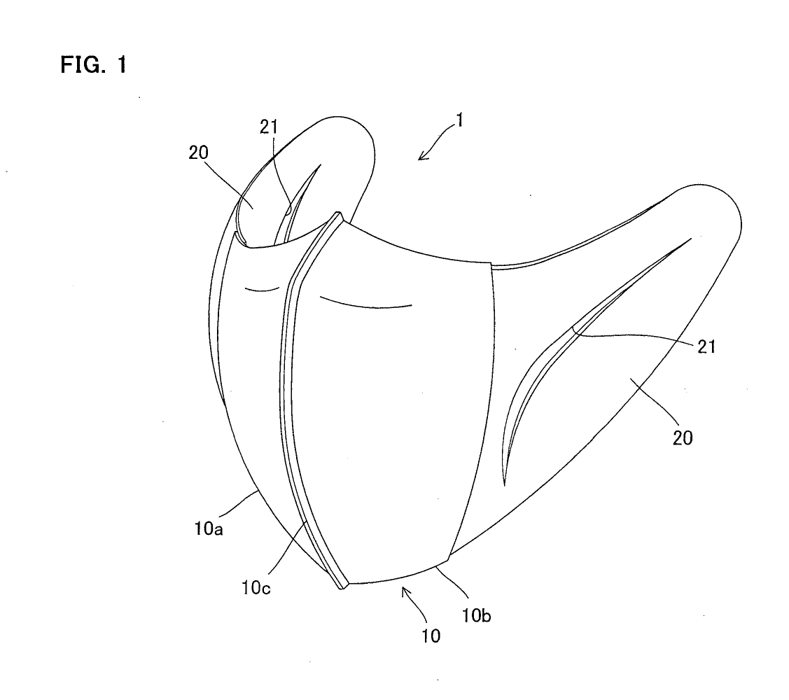

FIG. 2 shows a sectional construction of a mask body 10 shown in FIG. 1.

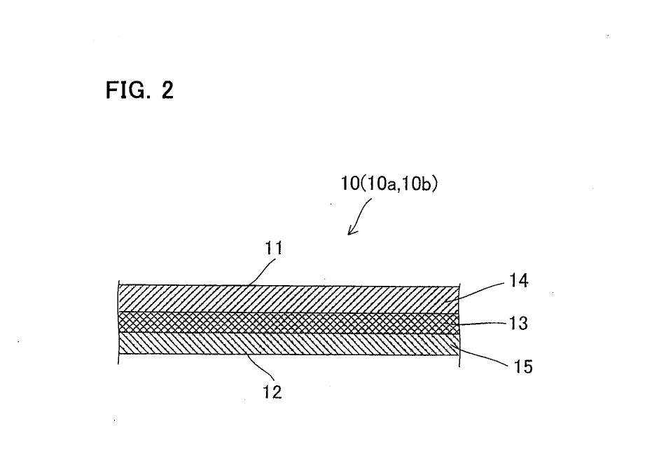

FIG. 3 shows measurements of the air permeability and the trapping efficiency of each of specimens of examples 1 to 10 and comparative examples 1 to 3 in this embodiment.

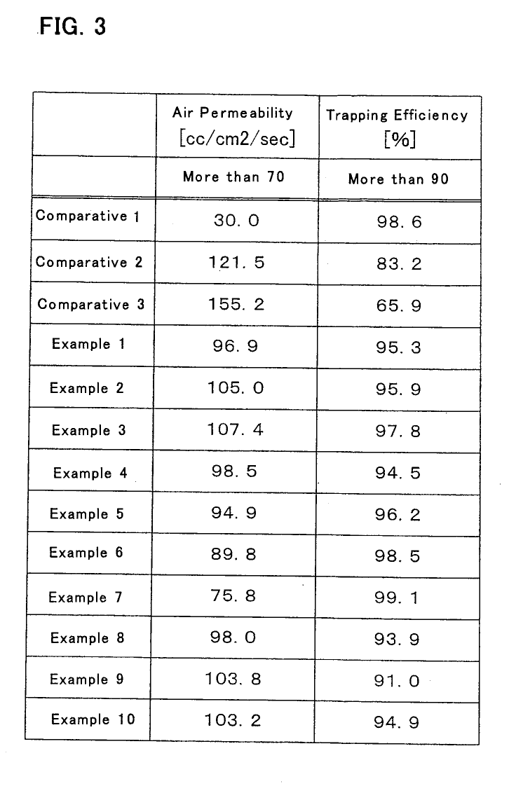

FIG. 4 is a graph showing the correlation between the air permeability and the trapping efficiency of each of the specimens of examples 1 to 10 and comparative examples 1 to 3 in this embodiment.

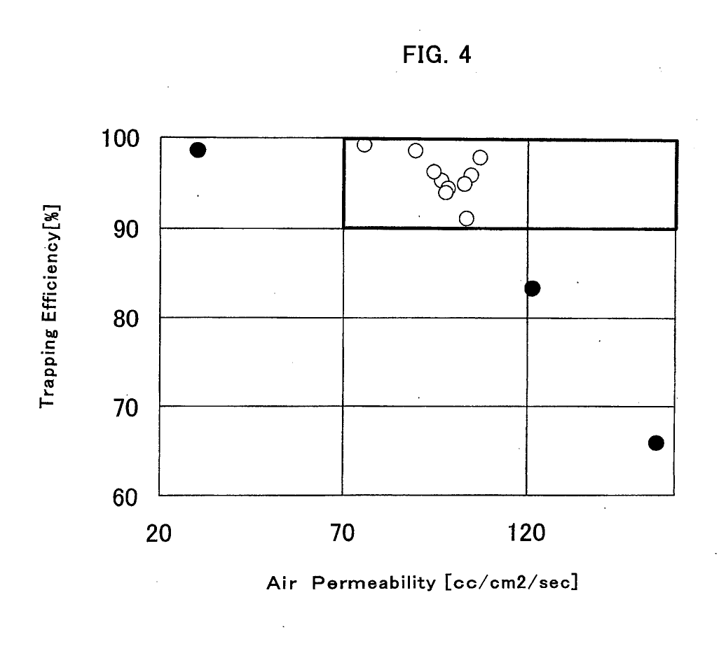

FIG. 5 is a graph showing the relationship between the average fiber diameter (μm) and the air permeability (%) and trapping efficiency (cc/cm²·sec) of a nonwoven fabric sheet corresponding to a first fiber sheet 13.

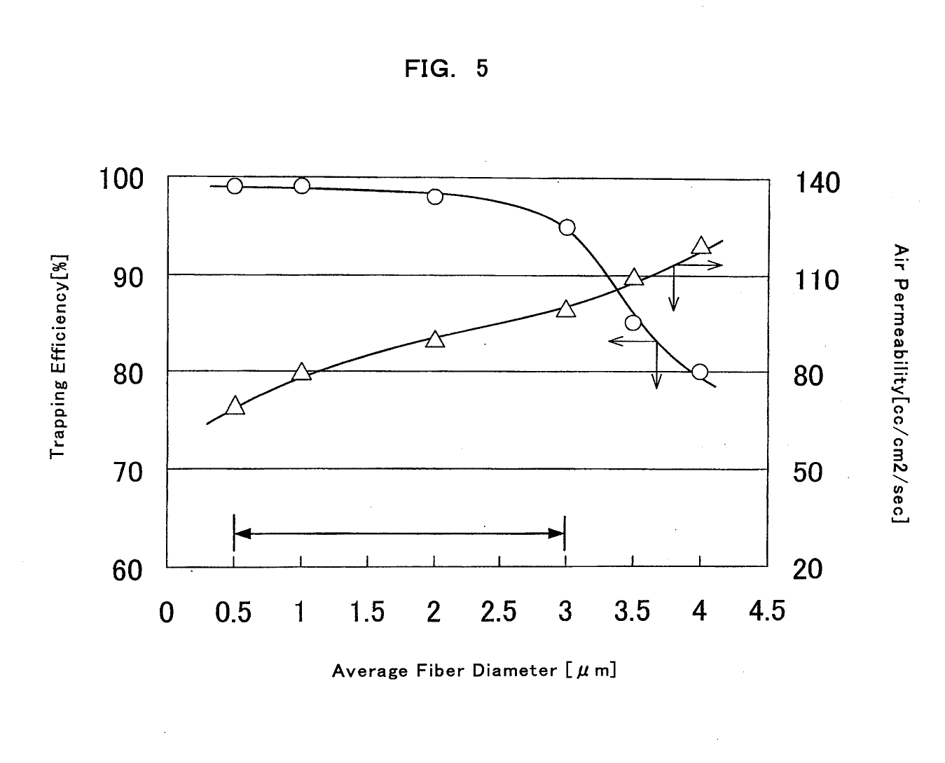

FIG. 6 is a graph showing the relationship between the basis weight (g/m²) and the air permeability (%) and trapping efficiency (cc/cm²·sec) of the nonwoven fabric sheet corresponding to the first fiber sheet 13.

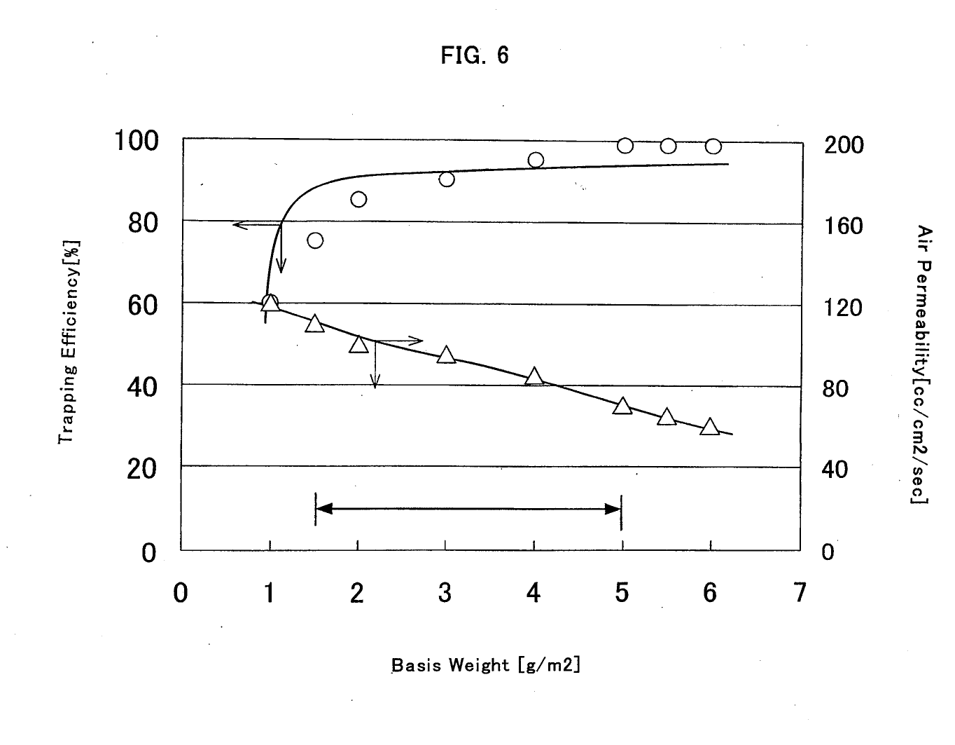

FIG. 7 is a graph showing the relationship between the average fiber diameter (μm) and the air permeability (%) and trapping efficiency (cc/cm²·sec) of a nonwoven fabric sheet corresponding to a second fiber sheet 14.

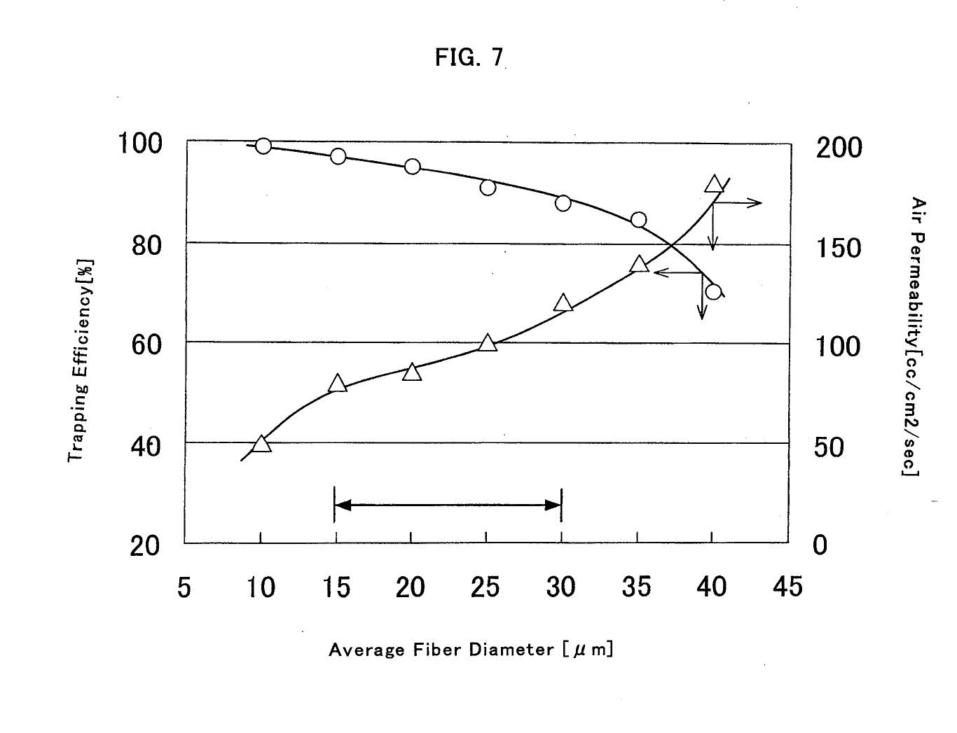

FIG. 8 is a graph showing the relationship between the basis weight (g/m²) and the air permeability (%) and trapping efficiency (cc/cm²·sec) of the nonwoven fabric sheet corresponding to the second fiber sheet 14.

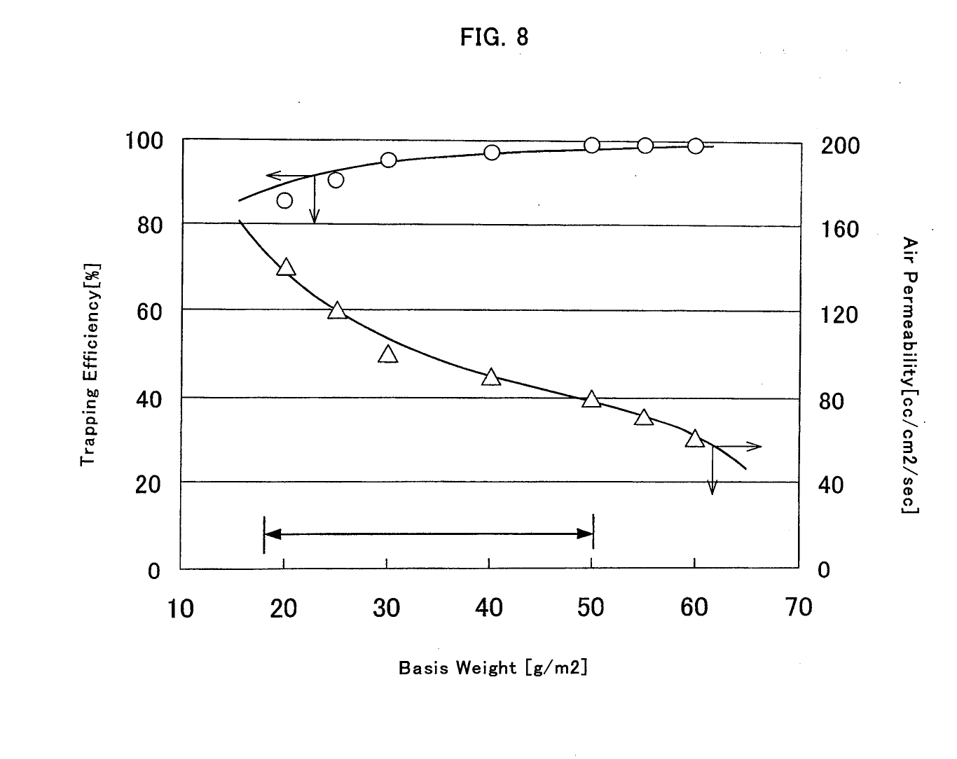

### DESCRIPTION OF NUMERALS

1 mask
10 mask body
10a right sheet piece
10b left sheet piece
10c joint edge
11 mask outer surface
12 mask inner surface
13 first fiber sheet
14 second fiber sheet
15 third fiber sheet
20 ear strap
21 opening

1. A mask comprising a mask body that covers at least wearer's mouth and nose and a pair of ear straps that extend from both sides of the mask body, the ear straps being hooked around wearer's ears wherein:
the mask body includes a first fiber sheet and a second fiber sheet which are defined by electret nonwoven fabric sheets formed of polyolefin fiber and stacked one on the other such that the first sheet is arranged on a wearer's side of the second fiber sheet when the mask is worn, and
the first fiber sheet comprises a nonwoven fabric sheet having an average fiber diameter of 0.5 to 3 μm and a basis weight of 1.5 to 5 g/m², and the second fiber sheet comprises a nonwoven fabric sheet having a larger average fiber diameter and a heavier basis weight than the first fiber sheet.

2. The mask according to claim 1, wherein the second fiber sheet comprises a nonwoven fabric sheet having an average fiber diameter of 15 to 30 μm and a basis weight of 18 to 50 g/m².

3. The mask according to claim 1 or 2, wherein the mask body has a third fiber sheet which is stacked on a side of the first fiber sheet opposite from the second fiber sheet, and the third fiber sheet comprises a nonwoven fabric sheet having an average fiber diameter of 10 to 50 μm and a basis weight of 20 to 40 g/m².
